(19) United States
(12) Patent Application Publication
(10) Pub. No.: US 2001/0040927 A1
(43) Pub. Date: Nov. 15, 2001

(54) Adaptive differential pulse code modulation system and method utilizing whitening filter for updating of predictor coefficients

(76) Inventor: Peter L. Chu, Lexington, MA (US)

Correspondence Address: CARR & FERRELL LLP, 2225 EAST BAYSHORE ROAD, SUITE 200, PALO ALTO, CA, 94303, US

(21) Appl. No.: 09/784,688

(22) Filed: Feb. 14, 2001

Related U.S. Application Data
(60) Provisional application No. 60/183,280, filed on Feb. 17, 2000.

(51) Int. Cl. H04B 1/10; H04B 14/04

(52) U.S. Cl. 375/254

(57) ABSTRACT

An improved technique for processing digital audio signals is provided wherein adaptation of predictor coefficients in an ADPCM environment is caused to converge in a rapid and computationally efficient manner. The technique employs a whitening filter to generate a filtered reconstructed signal which is utilized to update, or adapt, the prediction coefficients of a pole-based predictor.

### CROSS REFERENCE TO RELATED APPLICATIONS

The present application claims the benefit of priority from U.S. Provisional patent application Ser. No. 60/183,280, entitled “Adaptive Differential Pulse Code Modulation System and Method Utilizing Whitening Filter For Updating Of Predictor Coefficients” filed on Feb. 17, 2000, which is incorporated by reference herein.

### BACKGROUND

1. Field of Invention

The present invention relates generally to encoding and decoding of digital audio signals, and more particularly to predictor adaptation in adaptive differential pulse code modulation (ADPCM) systems.

2. Description of the Prior Art

FIG. 1 may be referenced in conjunction with the following discussion. ADPCM is a well-known technique for encoding speech and other audio signals for subsequent transmission over a network. A standard implementation of such a system is described in the International Telecommunication Union (ITU-T) Recommendation G.722, 7 kHz Audio-Coding Within 64 kBit/s, which is incorporated by reference herein.

As described in U.S. Pat. No. 4,317,208, issued Feb. 23, 1982 to Araseki et al. and incorporated by reference herein, a differential pulse code modulation system is a band compression system in which a prediction of each signal sample at a present time period is based on signal samples at past time periods. Such a process is particularly effective with voice and similar band signals due to their high degree of correlation between successive signal samples. A predicted signal Sⱼ at a time j is typically derived at a transmitter 102 by the general equation:

Sⱼ=A₁Sⱼ₋₁+A₂Sⱼ₋₂+ . . . AₙSⱼ₋ₙ;

where A₁, A₂, . . . Aₙ are termed the prediction coefficients. The prediction coefficients are selected to minimize the difference between an input signal Yⱼ and the predicted signal Sⱼ thus minimizing a prediction error Eⱼ which is in turn quantized and transmitted to a receiver 104, thereby requiring significantly less transmission bandwidth than would the input signal. The receiver 104 works in a manner generally the reverse of the transmitter 102, thereby reconstructing the input signal.

The characteristics of a voice or related audio signal vary with time, consequently the optimum coefficient values also vary. One method of attempting to efficiently derive prediction coefficients is to adapt them with the goal of minimizing the prediction error Eⱼ while such error is being observed, which could generally describe an ADPCM system. A common type of predictor employed in these systems is a pole-based predictor, such as predictors 110 and 126, which utilizes a feedback loop to minimize the energy in the prediction error signal Eⱼ, which is sometimes referred to as the difference or residual signal.

Due to the reality of frequent transmission errors between the transmitter 102 and the receiver 104, the prediction errors Êⱼ (which have been inverse quantized) produced at the receiver 104, and thus the reconstructed input signal Śⱼ depending thereon, has a tendency to diverge from the real input signal Yⱼ received at the transmitter 102. To gradually eliminate the adverse effect of the transmission errors, the prediction coefficients are typically derived by the general equation:

Aᵢ^{j+1}=Aᵢ^{j}(1−δ)+g·F₁(S¹ⱼ₋₁)·F₂(Êⱼ);

where j=1 to n, δ is a positive value much smaller than 1, g is a proper positive constant, Śⱼ₋ᵢ is a reconstructed input signal delayed i samples, and F₁ and F₂ are non-decreasing functions. The receiver 104 prediction coefficient values are tracked, or gradually caused to converge to those of the transmitter 102, by operation of the term (1−δ). The detrimental effect of transmission errors is thus partially overcome.

Instability or oscillation of the receiver may still occur in pole-based predictor systems due to the feedback loop to the predictor, which uses the prediction error signal Êⱼ and the preceding reconstructed input signal Śⱼ₋ᵢ to derive the prediction coefficients as described above. Stability checking is often used to ensure that the prediction coefficients remain in desired ranges, but at the expense of increased complexity as the number of poles, i.e., coefficients, increases.

In U.S. Pat. No. 4,317,208, Araseki et al. describe a system that also employs zero-based predictors, such as predictors 120 and 128, which do not utilize a feedback loop but which are known to provide less predictor gain than pole-based predictors and consequently inhibit or slow down the adaptation process. They propose that such a combination of pole-based and zero-based predictors may overcome the instability issues described above, and gain the advantages of each type of predictor.

In U.S. Pat. No. 4,593,398, issued Jun. 3, 1986 to Millar and incorporated by reference herein, it is suggested that a pole-based predictor, even coupled with a zero-based predictor, is still vulnerable to mistracking if the input signal contains two tones of equal amplitude but different frequencies. Millar notes that certain input signals may cause the pole-based predictor adaptation driven by the feedback loop to have multiple stable states, thus the receiver 104 may stabilize with its prediction coefficients at values different than the transmitter 102. This in turn is likely to cause a distorted frequency response at the receiver 104 and its associated audio output device.

The Millar patent proposes to mitigate the problems associated with lower predictor gain in zero-based predictors and mistracking in pole-based predictors. The system described by Millar and depicted in FIG. 1 is such that the predictor means in the transmitter 102 and the receiver 104 derive the prediction coefficients based on an algorithm including a non-linear function having no arguments comprising the value of the reconstructed input signal, such as signals Śⱼ and Śⱼ₋ᵢ. This coefficient adaptation is depicted by arrows 119 and 127. This is in contrast to the Araseki system wherein the prediction coefficients are partially derived from a reconstructed input signal such as signal Śⱼ₋ᵢ, which is dependent upon the predicted signal Sⱼ, which is dependent upon all of the immediate past coefficient values.

It is postulated that the Millar system and method may be computationally expensive to implement. Therefore what is needed is a system and methods in which the convergence to the optimal prediction coefficients, and thus to the predicted signal Sⱼ, occurs more rapidly and efficiently than in prior art systems.

### SUMMARY

An improved adaptive differential pulse code modulation (ADPCM) system and method comprises an encoder and a decoder linked together by a network connection and configured for processing digital audio signals. More particularly, the technique described is related to adaptation of predictor coefficients in an ADPCM environment. The components of the system may be implemented in software form as instructions executable by a processor or in hardware form as digital circuitry. Furthermore, devices implementing the system and method described are preferably configured to include both an encoder and a decoder for bidirectional communication with a similarly situated remote device, or may be configured with solely the encoder or decoder.

At the encoder, a digitized input signal is applied to a subtractor, which derives a difference signal by subtracting from the input signal a predicted signal generated by a pole-based predictor. After quantizing, transmitting to a decoder, and inverse quantizing, the difference signal is added to the predicted signal by an adder to provide a reconstructed input signal, which is fed back to the predictor and to the subtractor. The encoder is additionally provided with a whitening filter for receiving the reconstructed input signal and applying thereto a filtering algorithm to generate a filtered reconstructed signal. The filtered reconstructed signal is utilized to update, or adapt, the prediction coefficients of the pole-based predictor, thus providing more rapid and computationally efficient convergence to optimal prediction coefficients.

The decoder operates in an inverse manner to the encoder, receiving the quantized difference signal from an encoder and processing it to reconstruct the input signal for delivery to sound reproducing means. It is noted that devices employing the ADPCM techniques described herein are interoperable with devices employing prior art techniques, for example, those described in ITU-T G.722. It is further noted that the techniques described herein may be adapted for various implementations, one example being the employment of a plurality of encoders and/or decoders for frequency sub-band processing.

Other embodiments of the invention comprise additional predictors at the encoder and the decoder, operating to maximize the signal-to-noise ratio for certain input signals. The additional predictors are preferably zero-based predictors, the output therefrom being summed with the pole-based predictor output to produce the predicted signal.

### BRIEF DESCRIPTION OF THE FIGURES

In the accompanying drawings:

FIG. 1 depicts a prior art ADPCM system;

FIG. 2 depicts an ADPCM system, in accordance with a first embodiment of the invention; and

FIG. 3 depicts another ADPCM system, in accordance with a second embodiment of the invention.

### DESCRIPTION OF PREFERRED EMBODIMENTS

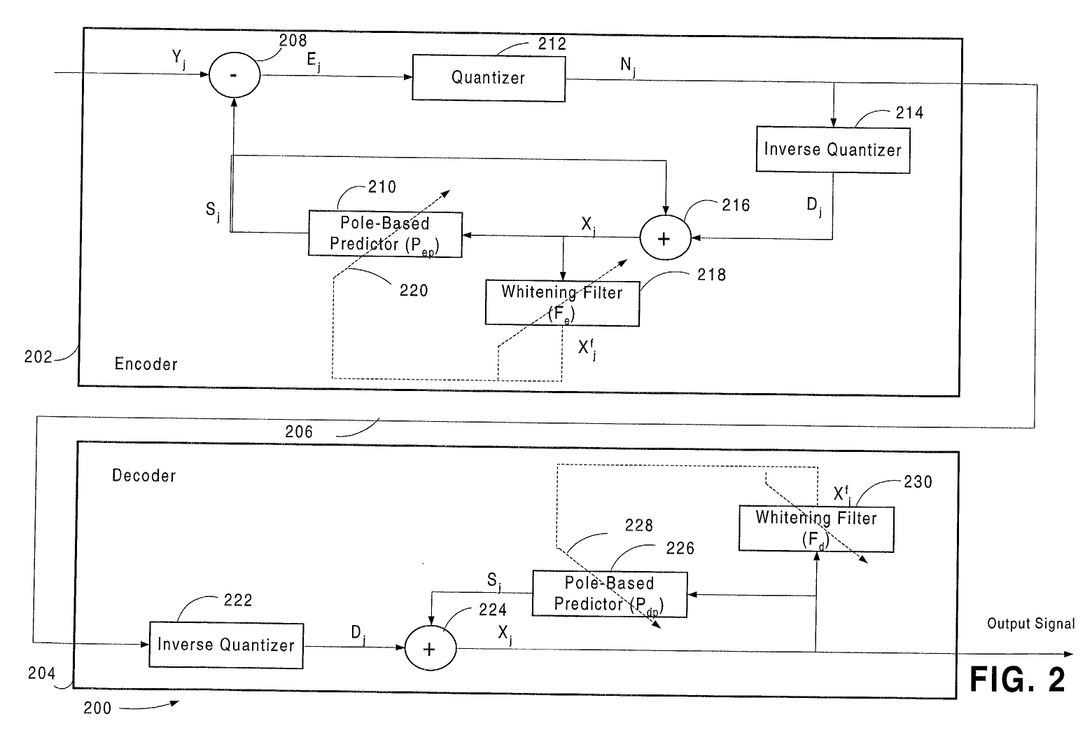

FIG. 2 depicts a first embodiment of an ADPCM system 200 in accordance with the invention. ADPCM system 200 comprises an encoder 202 and decoder 204 linked in communication by a network connection 206, such as an ISDN line, fractional T1 line, digital satellite link, wireless modems, or like digital transmission service. At encoder 202, a digitized input signal, typically representative of speech, is applied to a conventional subtractor 208. The input signal is represented as Yⱼ, signifying a value at sample period j. Subtractor 208 derives a difference signal Eⱼ by subtracting from input signal Yⱼ a predicted signal Sⱼ generated by a pole-based predictor 210. The difference signal Eⱼ is quantized by a conventional quantizer 212 to obtain a quantized numerical representation Nⱼ for transmission to decoder 204 over the network connection 206. Quantizer 112 is preferably of the adaptive type, but a quantizer utilizing fixed step sizes may also be used.

Numerical representation Nⱼ is also applied to a conventional inverse quantizer 214, which derives a regenerated difference signal Dⱼ. A conventional adder 216 adds regenerated difference signal Dⱼ to a predicted signal Sⱼ (output by the pole-based predictor 210) to provide a reconstructed input signal Xⱼ. The reconstructed input signal Xⱼ is in turn applied to the pole-based predictor 210, which calculates the predicted signal Sⱼ in accordance with the following equation:

$${S}_{j} = {a}_{1}^{j} {S}_{j - 1} + {a}_{2}^{j} {S}_{j - 2} + … + {a}_{n}^{j} {S}_{j - n}$$

where Sⱼ₋₁ is a stored value of the predicted signal at sample period j−1, Sⱼ₋₂ is a stored value of the predicted signal at sample period j−2, and so on, and a₁^{j} to aₙ^{j} are the predictor coefficients at sample period j, where n corresponds to the total number of poles (i.e., coefficients) of pole-based predictor 210. In one implementation of ADPCM system 200, the pole-based predictor 210 is limited to two poles, yielding the relation:

$${S}_{j} = {a}_{1}^{j} {S}_{j - 1} + {a}_{2}^{j} {S}_{j - 2} .$$

The predicted signal Sⱼ generated by predictor 210 is then applied to adder 216, completing the feedback loop.

Predictor coefficients a₁^{j} and a₂^{j} are updated in accordance with the generalized equations:

$${a}_{1}^{j + 1} = {a}_{1}^{j} ( 1 - {δ}_{1} ) + {g}_{1} \cdot {F}_{1} ( {X}_{j}^{f} , {X}_{j - 1}^{f} , {X}_{j - 2}^{f} )$$

$${a}_{2}^{j + 1} = {a}_{2}^{j} ( 1 - {δ}_{2} ) + {g}_{2} \cdot {F}_{2} ( {X}_{j}^{f} , {X}_{j - 1}^{f} , {X}_{j - 2}^{f} , {X}_{j - 3}^{f} , {a}_{1}^{j} )$$

where X^{f}ⱼ is a filtered version of reconstructed input signal Xⱼ at sample period j; δ₁, δ₂, g₁ and g₂ are proper positive constants, and F₁ and F₂ are nonlinear functions which may consist of correlations, sign-correlations, or other relationships. Calculation of the filtered reconstructed signal X^{f}ⱼ is discussed below.

In general, whitening filters modify the spectrum of signals to provide a flatter signal spectrum, so that there is less variation of energy as a function of frequency. It is noted that a perfect white noise signal has equal energy at every frequency. Stochastic gradient adaptive filters generally converge more rapidly with white signals than with non-white signals. Therefore, the use of a whitening filter in the present system and method is preferred at least for its effect on convergence of the adaptive pole-based predictors 210 and 226.

Referring back to FIG. 2, a whitening filter 218 receives the reconstructed input signal Xⱼ and applies thereto a filtering algorithm to generate a filtered reconstructed signal X^{f}ⱼ. To ensure stable operation of whitening filter 218, the filter coefficients a₂^{f}^{^{j+1}} and a₁^{f}^{^{j+1}} undergo the clamping set forth below at every other time step (i.e., for odd values of j):

a₂^{f}^{^{j+1}} is clamped to a maximum of 12288 and a minimum of −12288; and

a₁^{f}^{^{j+1}} is i clamped in magnitude to 15360−a₂^{f}^{^{j+1}}.

Implementation of this clamping routine is exemplified as:

temp=15360−a₂^{f}^{^{j+1}};

if a₁^{f}^{^{j+1}}>temp, then a₁^{f}^{^{j+1}} is set to equal temp;

if a₁^{f}^{^{j+1}}<−temp, then a₁^{f}^{^{j+1}} is set to equal −temp.

The filtered reconstructed signal X^{f}ⱼ output by whitening filter 218 is utilized to update the predictor coefficients a₁^{j+1} and a₂^{j+1}, as described above and indicated on FIG. 2 by arrow 220.

According to a preferred implementation, whitening filter 218 has two zeroes, yielding the relation:

Xⱼ^{f}=Xⱼ−a₁^{f}Xⱼ₋₁−a₂^{f}Xⱼ₋₂

where a^{f}₁ and a^{f}₂ are the first and second order filter coefficients. The filter coefficients a^{f}₁ and a^{f}₂ are updated at each time step j in accordance with the following equations:

$$\begin{matrix}{a}_{2}^{{f}^{j + 1}} = {a}_{2}^{{f}^{j}} ( 1 - ( \frac{256}{32768} ) ) - ( \frac{1}{32} ) {a}_{1}^{{f}^{j}} sgn [ {X}_{j}^{f} ] sgn [ {X}_{j - 1}^{f} ] + \\ 128 * sgn [ {X}_{j}^{f} ] sgn [ {X}_{j - 2}^{f} ] ; and\end{matrix}$$

$${a}_{1}^{{f}^{j + 1}} = {a}_{1}^{{f}^{j}} ( 1 - ( \frac{128}{32768} ) ) + 192 * sgn [ {X}_{j}^{f} ] sgn [ {X}_{j - 1}^{f} ] ;$$

where sgn [ ] is the sign function that returns a value of 1 for a nonnegative argument and a value of −1 for a negative argument.

In accordance with a computationally economical implementation of ADPCM system 200, the values of the predictor coefficients may be frozen at every other sample interval j. It should be noted that by recalculating predictor coefficients for pole-based predictor 210 only at every other interval, computational resources are conserved. This implementation is described by the following equations:

for even j:

a₂^{j+1}=a₂^{j}; and

a₁^{j+1}=a₁^{j};

else for odd j:

$$\begin{matrix}{a}_{2}^{j + 1} = {a}_{2}^{j - 1} ( 1 - ( \frac{510}{32768} ) ) - ( \frac{1016}{32768} ) lim [ {a}_{1}^{j - 1} ] sgn [ {X}_{j - 1}^{f} ] sgn [ {X}_{j - 2}^{f} ] + \\ 127 * sgn [ {X}_{j - 1}^{f} ] sgn [ {X}_{j - 3}^{f} ] - ( \frac{1}{32} ) lim [ {a}_{1}^{j - 1} ] sgn [ {X}_{j}^{f} ] sgn [ {X}_{j - 1}^{f} ] + \\ 128 * sgn [ {X}_{j}^{f} ] sgn [ {X}_{j - 2}^{f} ] ;\end{matrix}$$

$$and$$

$$\begin{matrix}{a}_{1}^{j + 1} = {a}_{1}^{j - 1} ( 1 - ( \frac{127.5}{32768} ) ) + 191.25 * sgn [ {X}_{j - 1}^{f} ] sgn [ {X}_{j - 2}^{f} ] + \\ 192 * sgn [ {X}_{j}^{f} ] sgn [ {X}_{j - 1}^{f} ] ;\end{matrix}$$

where sgn [ ] is the sign function that returns a value of 1 for a nonnegative argument and a value of −1 for a negative argument, and

$$lim [ {a}_{1}^{j - 1} ] = {a}_{1}^{j - 1} for - 8192 \leq {a}_{1}^{j - 1} \leq 8191 ;$$

$$lim [ {a}_{1}^{j - 1} ] = - 8192 for {a}_{1}^{j - 1} < - 8192 ; \text{and}$$

$$lim [ {a}_{1}^{j - 1} ] = 8191 for {a}_{1}^{j - 1} > 8191.$$

To ensure stability, a₂^{j+1} and a₁^{j+1} are clamped similarly to a₁^{f}^{^{j+1}} and a₁^{f}^{^{j+1}} as described above. That is:

a₂^{j+1} is clamped to a maximum of 12288 and a minimum of −12288; and

a₁^{j+1} is clamped in magnitude to 15360−α₂^{j+1}.

Implementation of this clamping routine is exemplified as:

temp=15360−a₂^{j+1};

if a₁^{j+1}>temp, then a₁^{j+1} is set to equal temp;

if a₁^{j+1}<−temp, then a₁^{j+1} is set to equal −temp.

Decoder 204 operates in an inverse manner to encoder 202. Inverse quantizer 222 receives the numerical representation Nⱼ over network connection 206 and derives the regenerated difference signal Dⱼ. Adder 224 sums the regenerated difference signal Dⱼ with the predicted signal Sⱼ generated by pole-based predictor 226 to produce the reconstructed input signal Xⱼ. The reconstructed input signal Xⱼ is then delivered to sound-reproducing means (which will typically include a D/A converter and loudspeaker) for reproduction of the speech represented by the input signal Yⱼ.

At the decoder 204, the reconstructed input signal Xⱼ is additionally applied to whitening filter 230 and pole-based predictor 226. Pole-based predictor 226 operates in a substantially identical manner to pole-based predictor 210 of encoder 202 and generates as output predicted signal Sⱼ, which is applied to adder 224 to complete the feedback loop. Whitening filter 230, which operates in a substantially identical manner to whitening filter 218 of encoder 202, provides as output a filtered reconstructed signal X^{f}ⱼ for use by pole-based predictor 226 in updating the predictor coefficients, as discussed above and indicated on FIG. 2 by arrow 228.

Those skilled in the art will recognize that the various components of encoder 202 and decoder 204 will typically be implemented in software form as program instructions executable by a general purpose processor. Alternatively, one or more components of encoder 202 and/or decoder 204 may be implemented in hardware form as digital circuitry.

Additionally, those skilled in the art will recognize that, although the pole-based predictors 210 and 226 are described above in terms of a two-pole implementation, the invention is not limited thereto and may be implemented in connection with pole-based predictors having any number of poles.

It is additionally noted that the ADPCM technique embodied in the invention may be adapted in various well-known ways in order to improve the speed and performance of the encoding and decoding processes. For example, a transmitting entity may break the input signal into a plurality of frequency-limited sub-bands, wherein each sub-band is applied to a separate encoder operating in a substantially identical manner to encoder 202. The sub-banded encoded signals are then multiplexed for transmission to a receiving entity over the network connection. The receiving entity then demultiplexes the received signal into a plurality of sub-banded signals and directs each sub-banded signal to a separate decoder operating in a manner substantially identical to decoder 204. The sub-banded reconstructed signals are thereafter combined and conveyed to sound-reproducing means.

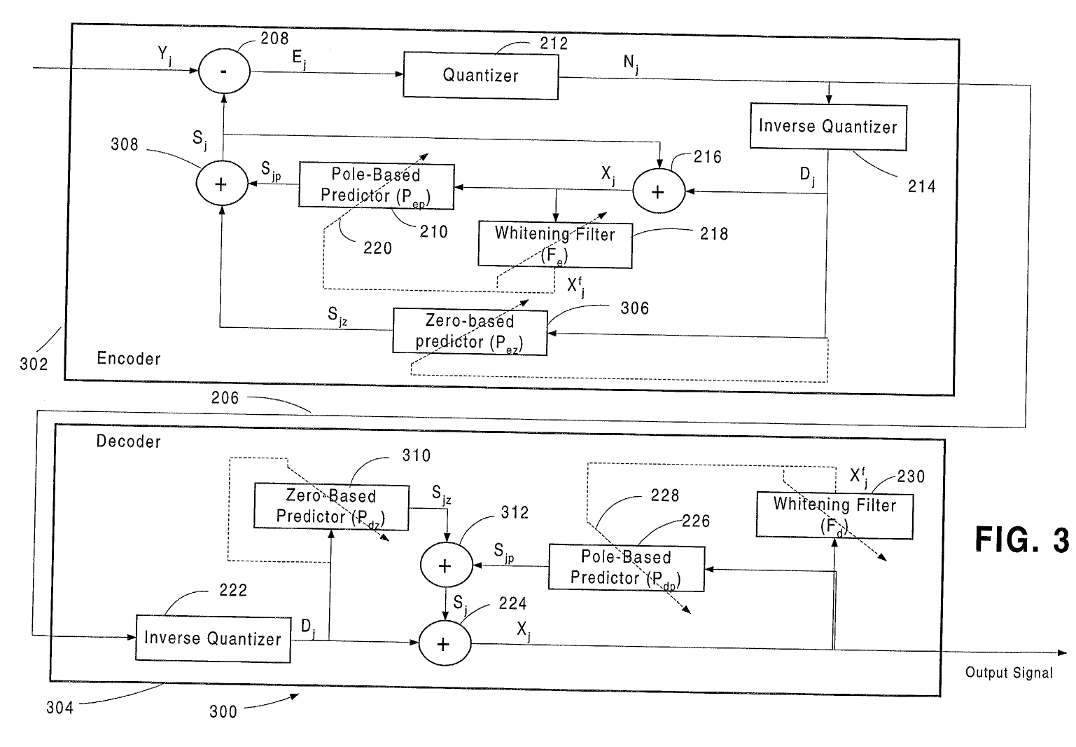

In other embodiments of the invention, additional predictors may be combined with the pole-based predictors to maximize the signal-to-noise ratio for certain input signals. Referring now to the FIG. 3 embodiment of an ADPCM system 300, encoder 302 differs from encoder 202 of the FIG. 2 embodiment by the addition of a conventional zero-based predictor 306. Zero-based predictor 306 receives the regenerated difference signal Dⱼ and produces a zero-based partial predicted signal S_{jz}, which is added to the partial pole-based predicted signal Sⱼₚ (equal to Sⱼ in the FIG. 2 embodiment) by adder 308 to provide predicted signal Sⱼ. Predicted signal Sⱼ is in turn applied to the feedback loop of pole-based predictor 210 and to subtractor 208. It is noted that zero-based predictor 306 does not have a feedback loop, and its predictor coefficients are conventionally updated with dependence on regenerated difference signal Dⱼ.

Similarly, decoder 304 differs from decoder 204 of the FIG. 2 embodiment by the inclusion of zero-based predictor 310. The regenerated difference signal Dⱼ is applied to zero-based predictor 310, which generates as output a zero-based partial predicted signal S_{jz}. Adder 312 combines the zero-based partial predicted signal S_{jz} with pole-based partial predicted signal Sⱼₚ provided by pole-based predictor 226 to produce the predicted signal Sⱼ.

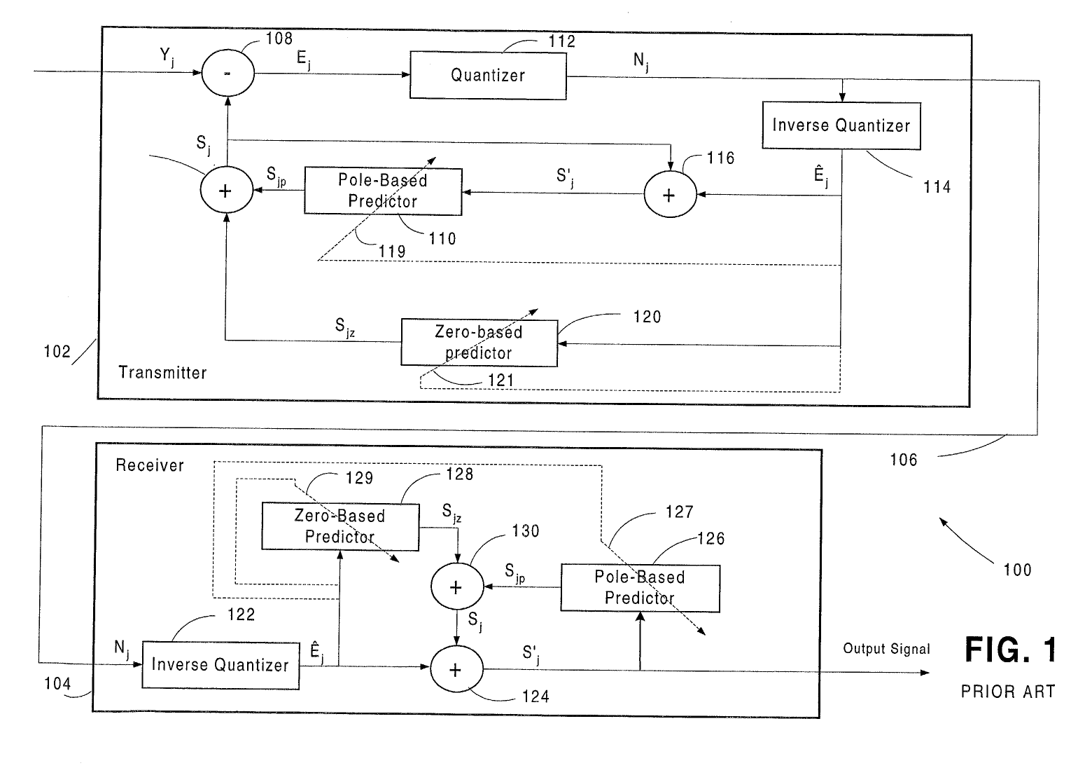

Another embodiment of the invention utilizes at least one look-up table in determining the proper coefficients for the predictors, i.e., pole-based predictors 210 and 226 of FIGS. 1 and 2, and/or zero-based predictors 306 and 310 of FIG. 3. For example, the first pole-based predictor coefficient is a function of three quantities: its former value, the sign of the current value of the sum of the quantized prediction error plus the all-zero predictor, and the sign of the past value of the sum of the quantized prediction error plus the all-zero predictor. In this embodiment, no arithmetic is necessary in determining a prediction coefficient value, however, identical input-output characteristics of the predictors are preserved.

It should be appreciated that devices utilizing the above-described ADPCM techniques, such as audioconferencing or videoconferencing endpoints, will typically be equipped for bi-directional communications over the network connection, and so will be provided with both an encoder (such as encoder 202 or 302) for encoding local audio for transmission to a remote endpoint as well as a decoder (such as decoder 204 or 304) for decoding audio signals received from the remote endpoint.

It is further noted that devices employing the above-described ADPCM techniques of the invention are advantageously interoperable with devices employing some prior art ADPCM techniques, such as those described in the aforementioned Millar reference and the ITU-T G.722 reference.

Finally, it is generally noted that while the invention has been particularly shown and described with reference to preferred embodiments thereof, it will be understood by those skilled in the art that various changes in form and details may be made therein without departing from the spirit and scope of the invention.

What is claimed is:

1. An adaptive differential pulse code modulation system comprising:
an encoder including:
a subtractor configured for deriving a difference signal Eⱼ, the difference signal Eⱼ being the difference between an input signal Yⱼ and a predicted signal Sⱼ, j representing a sample period;
a quantizer configured for quantizing the difference signal Eⱼ to obtain a numerical representation Nⱼ for transmission to an encoder inverse quantizer for deriving a regenerated difference signal Dⱼ, and to a decoder inverse quantizer coupled to the quantizer through a network for deriving the regenerated difference signal Dⱼ,
an encoder adder configured for deriving a reconstructed input signal Xⱼ, the reconstructed input signal Xⱼ being the sum of the regenerated difference signal Dⱼ and the predicted signal Sⱼ;
an encoder whitening filter Fe configured for receiving the reconstructed input signal Xⱼ and for generating a filtered reconstructed signal X^{f}ⱼ, the
Xⱼ^{f}=Xⱼ−a₁^{f}Xⱼ₋₁a₂^{f}Xⱼ₋₂− . . . aₙ^{f}Xⱼ₋ₙ
filtered reconstructed signal X^{f}ⱼ being generated according to the equation:
Xⱼ, being a value of reconstructed input signal Xⱼ at sample period j−n, and;
n being a number of filter tap coefficients a^{f}ₙ corresponding to the whitening filter Fₑ;
an encoder predictor Pₑₚ configured for receiving the reconstructed input signal Xⱼ and for generating a predicted signal Sⱼₚ, the predicted signal Sⱼₚ being at least constituent to predicted signal Sⱼ and being generated according to the equation:
$${S}_{jp} = {a}_{1}^{j} {S}_{j - 1} + {a}_{2}^{j} {S}_{j - 2} … {a}_{np}^{j} {S}_{j - np}$$
Sⱼ₋ₙₚ being a value of the predicted signal Sⱼ at sample period j−nₚ, and
nₚ being a number of predictor coefficients a^{j}ₙₚ corresponding to the predictor Pₑₚ; and
an encoder feedback loop configured for applying the predicted signal Sⱼ to the adder;
transmission means configured for transmitting the numerical representation Nⱼ from the encoder to a decoder; and
the decoder including:
the decoder inverse quantizer coupled to the quantizer through a network and configured for receiving the numerical representation Nⱼ and for deriving the regenerated difference signal Dⱼ therefrom,
a decoder adder configured for deriving the reconstructed input signal Xⱼ, the reconstructed input signal Xⱼ being the sum of the regenerated difference signal Dⱼ and the predicted signal Sⱼ;
a decoder whitening filter F_{d} configured for receiving the reconstructed input signal Xⱼ and for generating the filtered reconstructed signal X^{f}ⱼ, the filtered reconstructed signal X^{f}ⱼ being generated according to the equation:
X^{f}ⱼ=Xⱼa^{f}₁Xⱼ₋₁−a^{f}₂Xⱼ₋₂− . . . a^{f}ₙXⱼ₋ₙ
Xⱼ₋ₙ being a value of reconstructed signal Xⱼ at sample period j−n, and n being the number of filter tap coefficients a^{f}ₙ corresponding to the whitening filter F_{d};
a decoder predictor P_{dp} configured for receiving the reconstructed input signal Xⱼ and for generating a predicted signal Sⱼₚ, the predicted signal Sⱼₚ being at least constituent to predicted signal Sⱼ and being generated according to the equation:
Sⱼₚ=a₁^{j}Sⱼ₋₁+a₂^{j}Sⱼ₋₂ . . . a^{j}ₙₚSⱼ₋ₙₚ
Sⱼ₋ₙₚ being a value of the predicted signal Sⱼ at sample period j−nₚ, and
nₚ being the number of predictor coefficients a^{j}ₙₚ corresponding to the predictor P_{dp}; and
a decoder feedback loop configured for applying the predicted signal Sⱼ to the decoder adder.

2. The system of claim 1, further comprising:
a second encoder predictor P_{ez} configured for receiving the regenerated difference signal Dⱼ and for generating a predicted signal Sⱼₓ;
a second encoder adder configured for deriving the predicted signal Sⱼ at the encoder, the predicted signal Sⱼ being the sum of the predicted signal Sⱼₚ and the predicted signal S_{jz};
a second decoder predictor P_{dz} configured for receiving the regenerated difference signal Dⱼ and for generating a predicted signal S_{jz}; and
a second decoder adder configured for deriving the predicted signal Sⱼ at the decoder, the predicted signal Sⱼ being the sum of the predicted signal Sⱼₚ and the predicted signal S_{jz}.

3. The system of claim 1 wherein:
nₚ is 2;
the predictor coefficient a₁^{j} is updated according to the equation:
a₁^{j+1}=a₁^{j}(1−δ₁)+g₁·F₁(Xⱼ^{f}, Xⱼ₋₁^{f}, Xⱼ₋₂^{f})
δ₁ and g₁ being proper positive constants, and
F₁ being a nonlinear function; and
the predictor coefficient a₂^{J} is updated according to the equation:
a₂^{j+1}=a₂^{j}(1−δ₂)+g₂·F₂(Xⱼ^{f}, Xⱼ₋₁^{f}, Xⱼ₋₂^{f}, a₁^{j});
δ₂ and g₂ being proper positive constants, and
F₂ being a nonlinear function.

4. The system of claim 1 wherein:
n is 2;
the filter tap coefficient a₁^{f} is updated at each sample period j according to the generalized equation:
a₁^{fj+1}=a₁^{fj}(1−δ₁)+g₁·F₁(Xⱼ^{f}, X^{f}ⱼ₋₁, Xⱼ₋₂^{f})
δ₁ and g₁ being proper positive constants, and
F₁ being a nonlinear function; and
the filter tap coefficients a₂^{f} is updated at each sample period j according to the generalized equation:
a₂^{fj+1}=a₂^{fj}(1−δ₂)+g₂·F₂(Xⱼ^{f}, Xⱼ₋₁^{f}, a₁^{fj})
δ₂ and g₂ being proper positive constants, and
F₂ being a nonlinear function.

5. The system of claim 4 wherein:
the filter tap coefficient a₁^{f}^{^{j}} is updated according to the equation:
$${a}_{1}^{{f}^{j + 1}} = {a}_{1}^{{f}^{j}} ( 1 - ( \frac{128}{32768} ) ) + 192 * sgn [ {X}_{j}^{f} ] sgn [ {X}_{j - 1}^{f} ] ; and$$
the filter tap coefficient a₂^{f}^{^{j}} is updated according to the equation:
$$\begin{matrix}{a}_{2}^{{f}^{j + 1}} = {a}_{2}^{{f}^{j}} ( 1 - ( \frac{256}{32768} ) ) - ( \frac{1}{32} ) {a}_{1}^{{f}^{j}} sgn [ {X}_{j}^{f} ] sgn [ {X}_{j - 1}^{f} ] + \\ 128 * sgn [ {X}_{j}^{f} ] sgn [ {X}_{j - 2}^{f} ] ;\end{matrix}$$
sgn[ ] being a sign function that returns a value of 1 for a nonnegative argument and a value of −1 for a negative argument.

6. The system of claim 5 wherein at every other sample period j,
the filter tap coefficient a^{fj+1}₂ is maintained in a range −12288≦a^{fj+1}₂≦12288; and
the filter tap coefficient a^{fj+1}₁ is maintained in a range −(15360−a^{fj+1}₂)≦a^{fj+1}₁≦(15360−a^{fj+1}₂);
whereby a^{fj+1}₁ is set equal to (15360−a^{fj+1}₂) when a^{fj+1}₁>15360−a^{fj+1}₂; and
whereby a^{fj+1}₁ is set equal to −(15360−a^{fj+1}₂) when a^{fj+1}₁21 −(15360−a^{fj+1}₂).

7. The system of claim 5, further comprising:
a second encoder predictor P_{ez} configured for receiving the regenerated difference signal Dⱼ and for generating a predicted signal S_{jz};
a second encoder adder configured for deriving the predicted signal Sⱼ at the encoder, the predicted signal Sⱼ being the sum of the predicted signal Sⱼₚ and the predicted signal S_{jz};
a second decoder predictor P_{dz} configured for receiving the regenerated difference signal Dⱼ and for generating a predicted signal S_{jz}; and
a second decoder adder configured for deriving the predicted signal Sⱼ at the decoder, the predicted signal Sⱼ being the sum of the predicted signal Sⱼₚ and the predicted signal S_{jz}.

8. The system of claim 1 wherein at every other sample period j, the predictor coefficient a^{j}ₙₚ corresponding to the predictors Pₑₚ and P_{dp} is maintained unchanged.

9. The system of claim 8, such that if for even j:
a₁^{j+1}=a₁^{j}; and
a₂^{j+1}=a₂^{j},
then for odd j:
$$\begin{matrix}{a}_{1}^{j + 1} = {a}_{1}^{j - 1} ( 1 - ( \frac{127.5}{32768} ) ) + 191.25 * sgn [ {X}_{j - 1}^{f} ] sgn [ {X}_{j - 2}^{f} ] + \\ 192 * sgn [ {X}_{j}^{f} ] sgn [ {X}_{j - 1}^{f} ] ,\end{matrix} and$$
$$\begin{matrix}{a}_{2}^{j + 1} = {a}_{2}^{j - 1} ( 1 - ( \frac{510}{32768} ) ) - ( \frac{1016}{32768} ) lim [ {a}_{1}^{j - 1} ] sgn [ {X}_{j - 1}^{f} ] sgn [ {X}_{j - 2}^{f} ] + \\ 127 * sgn [ {X}_{j - 1}^{f} ] sgn [ {X}_{j - 3}^{f} ] - ( \frac{1}{32} ) lim [ {a}_{1}^{j - 1} ] sgn [ {X}_{j}^{f} ] sgn [ {X}_{j - 1}^{f} ] + \\ 128 * sgn [ {X}_{j}^{f} ] sgn [ {X}_{j - 2}^{f} ] ,\end{matrix}$$
sgn[ ] being a sign function that returns a value of 1 for a nonnegative argument and a value of −1 for a negative argument, and
lim[a₁^{j-1}]=a₁^{j-1} for −8192≦a₁^{j-1}≦8191,
lim[a₁^{j-1}]=−8192 for a₁^{j-1}<−8191, and
lim[a₁^{j-1}]=8192 for a₁^{j-1}>8191.

10. An encoder for encoding digital audio signals, comprising:
a subtractor configured for deriving a difference signal Eⱼ, the difference signal Eⱼ being the difference between an input signal Yⱼ and a predicted signal Sⱼ, j representing a sample period;
a quantizer configured for quantizing the difference signal Eⱼ to obtain a numerical representation Nⱼ for transmission to an encoder inverse quantizer for deriving a regenerated difference signal Dⱼ, and to a decoder inverse quantizer coupled to the quantizer for deriving the regenerated difference signal Dⱼ;
an adder configured for deriving a reconstructed input signal Xⱼ, the reconstructed input signal Xⱼ being the sum of the regenerated difference signal Dⱼ and the predicted signal Sⱼ;
a whitening filter configured for receiving the reconstructed input signal Xⱼ and for generating a filtered reconstructed signal X^{f}ⱼ, the filtered reconstructed signal X^{f}ⱼ being generated according to the equation:
X^{f}ⱼ=Xⱼ−a^{f}₁Xⱼ₋₁−a^{f}₂Xⱼ₋₂− . . . a^{f}ₙX^{f}ⱼ₋ₙ
X^{f}ⱼ₋ₙ being a value of filtered reconstructed signal X^{f}ⱼ at sample period j−n, and
n being a number of filter tap coefficients a^{f}ₙ corresponding to the whitening filter;
a predictor configured for receiving the reconstructed input signal Xⱼ and for generating a predicted signal Sⱼₚ, the predicted signal Sⱼₚ being at least constituent to predicted signal Sⱼ and being generated according to the equation:
Sⱼₚ=a^{j}₁Sⱼ₋₁−a^{j}₂Sⱼ₋₂− . . . a^{j}ₙₚSₙ₋ₙₚ
Sⱼ₋ₙₚ being a value of the predicted signal Sⱼ at sample period j−nₚ, and
nₚ being a number of predictor coefficients a^{j}ₙₚ corresponding to the predictor; and
a feedback loop configured for applying the predicted signal Sⱼ to the adder.

11. The system of claim 10, the encoder further comprising:
a second predictor configured for receiving the regenerated difference signal Dⱼ and for generating a predicted signal S_{jz}, the predicted signal S_{jz} being at least constituent to predicted signal Sⱼ; and
a second adder configured for deriving the predicted signal Sⱼ, the predicted signal Sⱼ being the sum of the predicted signal Sⱼₚ and the predicted signal S_{jz}.

12. The system of claim 10 wherein:
n is 2;
the filter tap coefficient a₁^{f} is updated at each sample period j according to the generalized equation:
a₁^{fj+1}=a₁^{fj}(1−δ₁)+g₁·F₁(Xⱼ^{f}, Xⱼ₋₁^{f}, Xⱼ₋₂^{f})
δ₁ and g₁ being proper positive constants, and
F₁ being a nonlinear function;
the filter tap coefficients a₂^{f} is updated at each sample period j according to the generalized equation:
a₂^{fj+1}=a₂^{fj}(1−δ₂)+g₂·F₂(Xⱼ^{f}, Xⱼ₋₁^{f}, Xⱼ₋₂^{f}, a₁^{fj})
δ₂ and g₂ being proper positive constants, and
F₂ being a nonlinear function.

13. The system of claim 12 wherein:
the filter tap coefficient a₁^{f} is updated according to the equation:
$${a}_{1}^{{f}^{j + 1}} = {a}_{1}^{{f}^{j}} ( 1 - ( \frac{128}{32768} ) ) + 192 * sgn [ {X}_{j}^{f} ] sgn [ {X}_{j - 1}^{f} ] and$$
the filter tap coefficient a₂^{f} is updated according to the equation:
$$\begin{matrix}{a}_{2}^{{f}^{j + 1}} = {a}_{2}^{{f}^{j}} ( 1 - ( \frac{256}{32768} ) ) - ( \frac{1}{32} ) {a}_{1}^{{f}^{j}} sgn [ {X}_{j}^{f} ] sgn [ {X}_{j - 1}^{f} ] + \\ 128 * sgn [ {X}_{j}^{f} ] sgn [ {X}_{j - 2}^{f} ] ,\end{matrix}$$
sgn[ ] being a sign function that returns a value of 1 for a nonnegative argument and a value of −1 for a negative argument.

14. The system of claim 13 wherein at every other sample period j,
the filter tap coefficient a^{fj+1}₂ is maintained in a range −12288≦a^{fj+1}₂≦12288; and
the filter tap coefficient a^{fj+1}₁ is maintained in a range −(15360−a^{fj+1}₂)≦a^{fj+1}₁≦(15360- a^{fj+1}₂);
whereby a^{fj+1}₁ is set equal to (15360−a^{fj+1}₂) when a^{fj+1}₁>15360−a^{fj+1}₂; and
whereby a^{fj+1}₁ is set equal to −(15360−a^{fj+1}₂) when a^{fj+1}₁<−(15360−a^{fj+1}₂).

15. The system of claim 10 wherein at every other sample period j, the predictor coefficient a^{j}ₙₚ corresponding to the predictor is maintained unchanged.

16. The system of claim 10, wherein the encoder is constituent to or coupled to a videoconferencing device or application.

17. A decoder for decoding digital audio signals encoded by a properly associated encoder, comprising:
an inverse quantizer coupled to the encoder and configured for receiving a numerical representation Nⱼ and for deriving a regenerated difference signal Dⱼ therefrom, the numerical representation Nⱼ being a quantized representation of a difference signal Eⱼ, the difference signal Eⱼ being the difference between an input signal Yⱼ and a predicted signal Sⱼ, j representing a sample period;
an adder configured for deriving a reconstructed input signal Xⱼ, the reconstructed input signal Xⱼ being the sum of the regenerated difference signal Dⱼ and the predicted signal Sⱼ;
a whitening filter configured for receiving the reconstructed input signal Xⱼ and for generating a filtered reconstructed signal X^{f}ⱼ, the filtered reconstructed signal X^{f}ⱼ being generated according to the equation:
X^{f}ⱼ=Xⱼ−a^{f}₁Xⱼ₋₁−a^{f}₂Xⱼ₋₂− . . . a^{f}ₙX^{f}ₙ₋ₙ
X^{f}ⱼ₋ₙ being a value of filtered reconstructed signal X^{f}ⱼ at sample period j−n, and
n being a number of filter tap coefficients a^{f}ₙ corresponding to the whitening filter;
a predictor configured for receiving the reconstructed input signal Xⱼ and for generating a predicted signal Sⱼₚ, the predicted signal Sⱼₚ being at least constituent to predicted signal Sⱼ and being generated according to the equation:
Sⱼₚ=a^{j}₁Sⱼ₋₁−a^{j}₂Sⱼ₋₂ . . . a^{j}ₙₚSⱼ₋ₙₚ
Sⱼ₋ₙₚ being a value of the predicted signal Sⱼ at sample period j−nₚ, and
nₚ being a number of predictor coefficients a^{j}ₙₚ corresponding to the predictor; and
a feedback loop configured for applying the predicted signal Sⱼ to the adder.

18. The system of claim 17, the decoder further comprising:
a second predictor configured for receiving the regenerated difference signal Dⱼ and for generating a predicted signal S_{jz}, the predicted signal S_{jz} being at least constituent to predicted signal Sⱼ; and
a second adder configured for deriving the predicted signal Sⱼ, the predicted signal Sⱼ being the sum of the predicted signal Sⱼₚ and the predicted signal S_{jz}.

19. The system of claim 17 wherein:
n is 2;
the filter tap coefficient a₁^{f} is updated at each sample period j according to the generalized equation:
a₁^{fj+1}=a₁^{fj}(1−δ₁)+g₁·F₁(Xⱼ^{f}, Xⱼ₋₁^{f}, Xⱼ₋₂^{f})
δ₁ and g₁ being proper positive constants, and
F₁ being a nonlinear function;
the filter tap coefficients a₂^{f} is updated at each sample period j according to the generalized equation:
a₂^{fj+1}=a₂^{fj}(1−δ₂)+g₂·F₂(Xⱼ^{f}, Xⱼ₋₁^{f}, Xⱼ₋₂^{f}, a₁^{fj})
δ₂ and g₂ being proper positive constants, and;
F₂ being a nonlinear function.

20. The system of claim 19 wherein:
the filter tap coefficient a₁^{f} is updated according to the equation:
$${a}_{1}^{{f}^{j + 1}} = {a}_{1}^{{f}^{j}} ( 1 - ( \frac{128}{32768} ) ) + 192 * sgn [ {X}_{j}^{f} ] sgn [ {X}_{j - 1}^{f} ] and$$
the filter tap coefficient a₂^{f} is updated according to the equation:
$$\begin{matrix}{a}_{2}^{{f}^{j + 1}} = {a}_{2}^{{f}^{j}} ( 1 - ( \frac{256}{32768} ) ) - ( \frac{1}{32} ) {a}_{1}^{{f}^{j}} sgn [ {X}_{j}^{f} ] sgn [ {X}_{j - 1}^{f} ] + \\ 128 * sgn [ {X}_{j}^{f} ] sgn [ {X}_{j - 2}^{f} ]\end{matrix}$$
sgn[ ] being a sign function that returns a value of 1 for a nonnegative argument and a value of −1 for a negative argument.

21. The system of claim 20 wherein at every other sample period j,
the filter tap coefficient a^{fj+1}₂ is maintained in a range −12288≦a^{fj+1}₂≦12288; and
the filter tap coefficient a^{fj+1}₁ is maintained in a range −(15360−a^{fj+1}₂)≦a^{fj+1}₁≦(15360−a^{fj+1}₂);
whereby a^{fj+1}₁ is set equal to (15360−a^{fj+1}₂) when a^{fj+1}₁>15360−a^{fj+1}₂; and
whereby a^{fj+1}₁ is set equal to −(15360−a^{fj+1}₂) when a^{fj+1}₁<−(15360−a^{fj+1}₂).

22. The system of claim 17 wherein at every other sample period j, the predictor coefficient a^{j}ₙₚ corresponding to the predictor is maintained unchanged.

23. The system of claim 17, wherein the decoder is constituent to or coupled to a videoconferencing device or application.

24. A method for encoding and decoding digital audio signals, comprising the steps of:
deriving a difference signal Eⱼ at an encoder, the difference signal Eⱼ being the difference between an input signal Yⱼ and a predicted signal Sⱼ, j representing a sample period;
quantizing the difference signal Eⱼ to obtain a numerical representation Nⱼ for transmitting to an encoder inverse quantizer for deriving a regenerated difference signal Dⱼ, and to a decoder inverse quantizer coupled to the quantizer through a network for deriving the regenerated difference signal Dⱼ;
deriving a reconstructed input signal Xⱼ at a first adder, the reconstructed input signal Xⱼ being the sum of the regenerated difference signal Dⱼ and the predicted signal Sⱼ;
receiving the reconstructed input signal Xⱼ at a whitening filter Fₑ;
generating a filtered reconstructed signal X^{f}ⱼ by the whitening filter Fₑ, the filtered reconstructed signal X^{f}ⱼ being generated according to the equation:
X^{f}ⱼ=Xⱼ−a^{f}₁Xⱼ₋₁−a^{f}₂Xⱼ₋₂− . . . a^{f}ₙX^{f}ⱼ₋ₙ
X^{f}ⱼ₋ₙ being a value of filtered reconstructed signal X^{f}ⱼ at sample period j−n, and
n being a number of filter tap coefficients a^{f}ₙ corresponding to the whitening filter Fₑ;
receiving the reconstructed input signal Xⱼ at a predictor Pₑₚ;
generating a predicted signal Sⱼₚ by the predictor Pₑₚ, the predicted signal Sⱼₚ being at least constituent to predicted signal Sⱼ and being generated according to the equation:
Sⱼₚ=a^{j}₁Sⱼ₋₁−a^{j}₂Sⱼ₋₂− . . . a^{j}ₙₚSⱼ₋ₙₚ
Sⱼ₋ₙₚ being a value of the predicted signal Sⱼ at sample period j−nₚ, and
nₚ being a number of predictor coefficients a^{j}ₙₚ corresponding to the predictor Pₑₚ;
applying the predicted signal Sⱼ to the first adder to provide feedback;
receiving the numerical representation Nⱼ at a decoder;
deriving the regenerated difference signal Dⱼ from the numerical representation Nⱼ,
deriving the reconstructed input signal Xⱼ at a second adder, the reconstructed input signal Xⱼ being the sum of the regenerated difference signal Dⱼ and the predicted signal Sⱼ;
receiving the reconstructed input signal Xⱼ at a whitening filter F_{d};
generating a filtered reconstructed signal X^{f}ⱼ by the whitening filter F_{d}, the filtered reconstructed signal X^{f}ⱼ being generated according to the equation:
X^{f}ⱼ=Xⱼ−a^{f}₁Xⱼ₋₁−a^{f}₂Xⱼ₋₂− . . . a^{f}ₙX^{f}ⱼ₋ₙ
X^{f}ⱼ₋ₙ being a value of filtered reconstructed signal X^{f}ⱼ at sample period j−n;
n being a number of filter tap coefficients a^{f}ₙ corresponding to the whitening filter F_{d};
receiving the reconstructed input signal Xⱼ at a predictor P_{dp};
generating a predicted signal Sⱼₚ by the predictor P_{dp}, the predicted signal Sⱼₚ being at least constituent to predicted signal Sⱼ and being generated according to the equation:
Sⱼₚ=a^{j}₁Sⱼ₋₁−a^{j}₂Sⱼ₋₂− . . . a^{j}ₙₚSⱼ₋ₙₚ
Sⱼ₋ₙₚ being a value of the predicted signal Sⱼ at sample period j−nₚ, and
nₚ being a number of predictor coefficients a^{j}ₙₚ corresponding to the predictor P_{dp}; and
applying the predicted signal Sⱼ to the second adder to provide feedback.

25. The method of claim 24, further comprising the steps of:
receiving the regenerated difference signal Dⱼ at a predictor P_{ez} at the encoder;
generating a predicted signal S_{jz} by the predictor P_{ez};
deriving the predicted signal Sⱼ at the encoder, the predicted signal Sⱼ being the sum of the predicted signal Sⱼₚ and the predicted signal S_{jz};
receiving the regenerated difference signal Dⱼ at a predictor P_{dz} at the decoder;
generating the predicted signal S_{jz} by the predictor P_{dz}; and
deriving the predicted signal Sⱼ at the decoder, the predicted signal Sⱼ being the sum of the predicted signal Sⱼₚ and the predicted signal S_{jz}.

26. The method of claim 24 wherein nₚ is 2, further comprising the steps of:
updating the predictor coefficient a₁^{j} according to the equation:
a₁^{j+1}=a₁^{j}(1−δ₁)+g₁·F₁(Xⱼ^{f}, Xⱼ₋₁^{f}, Xⱼ₋₂^{f})
δ₁ and g₁ being proper positive constants, and
F₁ being a nonlinear function; and
updating the predictor coefficient a₂^{j} according to the equation:
a₂^{j+1}=a₂^{j}(1−δ₂)+g₂·F₂(Xⱼ^{f}, Xⱼ₋₁^{f}, Xⱼ₋₂^{f}, a₁^{j})
δ₂ and g₂ being proper positive constants, and;
F₂ being a nonlinear function.

27. The method of claim 24 wherein n is 2, further comprising the steps of:
updating the filter tap coefficient a₁^{f} at each sample period j according to the generalized equation:
a₁^{fj+1}=a₁^{fj}(1−δ₁)+g₁·F₁(Xⱼ^{f}, Xⱼ₋₁^{f}, Xⱼ₋₂^{f})
δ₁ and g₁ being proper positive constants, and
F₁ being a nonlinear function; and
updating the filter tap coefficients a₂^{f} at each sample period j according to the generalized equation:
a₂^{fj+1}=a₂^{fj}(1−δ₂)+g₂·F₂(Xⱼ^{f}, Xⱼ₋₁^{f}, a₁^{fj})
δ₂ and g₂ being proper positive constants, and
F₂ being a nonlinear function.

28. The method of claim 27 wherein:
the filter tap coefficient a₁^{f} is updated according to the equation:
$${a}_{1}^{{f}^{j + 1}} = {a}_{1}^{{f}^{j}} ( 1 - ( \frac{128}{32768} ) ) + 192 * sgn [ {X}_{j}^{f} ] sgn [ {X}_{j - 1}^{f} ] , and$$
the filter tap coefficient a₂^{f} is updated according to the equation:
$$\begin{matrix}{a}_{2}^{{f}^{j + 1}} = {a}_{2}^{{f}^{j}} ( 1 - ( \frac{256}{32768} ) ) - ( \frac{1}{32} ) {a}_{1}^{{f}^{j}} sgn [ {X}_{j}^{f} ] sgn [ {X}_{j - 1}^{f} ] + \\ 128 * sgn [ {X}_{j}^{f} ] sgn [ {X}_{j - 2}^{f} ]\end{matrix}$$
sgn[ ] being a sign function that returns a value of 1 for a nonnegative argument and a value of −1 for a negative argument.

29. The method of claim 28 wherein at every other sample period j,
the filter tap coefficient a^{fj+1}₂ is maintained in a range −12288≦a^{fj+1}₂≦12288; and
the filter tap coefficient a^{fj+1}₁ is maintained in a range −(15360−a^{fj+1}₂)≦a^{fj+1}₁≦(15360−a^{fj+1}₂);
whereby a^{fj+1}₁ is set equal to (15360−a^{fj+1}₂) when a^{fj+1}₁22 15360−a^{fj+1}₂; and
whereby a^{fj+1}₁ is set equal to −(15360−a^{fj+1}₂) when a^{fj+1}₁<−(15360−a^{fj+1}₂).

30. The method of claim 28, further comprising the steps of:
receiving the regenerated difference signal Dⱼ at a predictor P_{ez} at the encoder;
generating a predicted signal S_{jz} by the predictor P_{dz};
deriving the predicted signal Sⱼ at the encoder, the predicted signal Sⱼ being the sum of the predicted signal Sⱼₚ and the predicted signal S_{jz};
receiving the regenerated difference signal Dⱼ at a predictor P_{dz} at the decoder;
generating the predicted signal S_{jz} by the predictor P_{dz}; and
deriving the predicted signal Sⱼ at the decoder, the predicted signal Sⱼ being the sum of the predicted signal Sⱼₚ and the predicted signal S_{jz}.

31. The method of claim 28 wherein nₚ is 2, further comprising the steps of:
updating the predictor coefficient a₁^{j} according to the equation:
a₁^{j+1}=a₁^{j}(1−δ₁)+g₁·F₁(Xⱼ^{f}, Xⱼ₋₁^{f}, Xⱼ₋₂^{f})
δ₁ and g₁ being proper positive constants, and
F₁ being a nonlinear function; and
updating the predictor coefficient a₂^{j} according to the equation:
a₂^{j+1}=a₂^{j}(1−δ₂)+g₂·F₂(Xⱼ^{f}, Xⱼ₋₁^{f}, Xⱼ₋₂^{f}, a₁^{j})
δ₂ and g₂ being proper positive constants, and;
F₂ being a nonlinear function.

32. A method for adapting coefficients in a two pole predictor in an adaptive differential pulse code modulation system, comprising the steps of:
generating a filtered reconstructed signal X^{f}ⱼ by a whitening filter Fₑ, the filtered reconstructed signal X^{f}ⱼ being generated according to the equation:
X^{f}ⱼ=Xⱼ−a^{f}₁Xⱼ₋₁−a^{f}₂Xⱼ₋₂− . . . a^{f}ₙX^{f}ₙ₋ₙ
X^{f}ⱼ₋ₙ being a value of filtered reconstructed signal X^{f}ⱼ at sample period j−n, and
n being a number of filter tap coefficients a^{f}ₙ corresponding to the whitening filter Fₑ;
updating a predictor coefficient a₁^{f} according to the equation:
a₁^{j+1}=a₁^{j}(1−δ₁)+g₁·F₁(Xⱼ^{f}, Xⱼ₋₁^{f}, Xⱼ₋₂^{f})
δ₁ and g₁ being proper positive constants, and
F₁ being a nonlinear function; and
updating a predictor coefficient a₂^{j} according to the equation:
$${a}_{2}^{j + 1} = {a}_{2}^{J} ( 1 - {δ}_{2} ) + {g}_{2} \cdot {F}_{2} ( {X}_{j}^{f} , {X}_{j - 1}^{f} , {X}_{j - 2}^{f} , {a}_{1}^{j} )$$
δ₂ and g₂ being proper positive constants, and
F₂ being a nonlinear function.

33. The method of claim 32, further comprising the steps of:
updating the filter tap coefficient a₁^{f} at each sample period j according to the generalized equation:
a₁^{fj+1}=a₁^{fj}(1−δ₁)+g₁·F₁(Xⱼ^{f}, Xⱼ₋₁^{f}, Xⱼ₋₂^{f})
δ₁ and g₁ being proper positive constants, and
F₁ being a nonlinear function; and
updating the filter tap coefficients a₂^{f} at each sample period j according to the generalized equation:
a₂^{fj+1}=a₂^{fj}(1−δ₂)+g₂·F₂(Xⱼ^{f}, Xⱼ₋₁^{f}, Xⱼ₋₂^{f}, a₁^{fj})
δ₂ and g₂ being proper positive constants, and
F₂ being a nonlinear function.

34. The method of claim 32 wherein:
the filter tap coefficient a₁^{f} is updated according to the equation:
$${a}_{1}^{{f}^{j + 1}} = {a}_{1}^{{f}^{j}} ( 1 - ( \frac{128}{32768} ) ) + 192 * sgn [ {X}_{j}^{f} ] sgn [ {X}_{j - 1}^{f} ] and$$
the filter tap coefficient a₂^{f} is updated according to the equation:
$$\begin{matrix}{a}_{2}^{{f}^{j + 1}} = {a}_{2}^{{f}^{j}} ( 1 - ( \frac{256}{32768} ) ) - ( \frac{1}{32} ) {a}_{1}^{{f}^{j}} sgn [ {X}_{j}^{f} ] sgn [ {X}_{j - 1}^{f} ] + \\ 128 * sgn [ {X}_{j}^{f} ] sgn [ {X}_{j - 2}^{f} ]\end{matrix}$$
sgn[ ] being a sign function that returns a value of 1 for a nonnegative argument and a value of −1 for a negative argument.

35. The method of claim 34 wherein at every other sample period j,
the filter tap coefficient a^{fj+1}₂ is maintained in a range −12288≦a^{fj+1}₂≦12288; and
the filter tap coefficient a^{fj+1}₁ is maintained in a range −(15360−a^{fj+1}₂)≦a^{fj+1}₁≦(15360−a^{fj+1}₂);
whereby a^{fj+1}₁ is set equal to (15360−a^{fj+1}₂) when a^{fj+1}₁>15360−a^{fj+1}₂; and
whereby a^{fj+1}₁ is set equal to −(15360−a^{fj+1}₂) when a^{fj+1}₁<−(15360−a^{fj+1}₂).

36. A machine readable medium embodying instructions executable by a machine to perform a method for adapting coefficients in a two pole predictor in an adaptive differential pulse code modulation system, the method steps comprising:
generating a filtered reconstructed signal X^{f}ⱼ by a whitening filter, the filtered reconstructed signal X^{f}ⱼ being generated according to the equation:
X^{f}ⱼ=Xⱼ−a^{f}₁Xⱼ₋₁−a^{f}₂Xⱼ₋₂− . . . a^{f}ₙX^{f}ⱼ₋ₙ
X^{f}ⱼ₋ₙ being a value of filtered reconstructed signal X^{f}ⱼ at sample period j−n, and
n being a number of filter tap coefficients a^{f}ₙ corresponding to the whitening filter;
updating a predictor coefficient a₁^{j} according to the equation:
a₁^{j+1}=a₁^{j}(1−δ₁)+g₁·F₁(Xⱼ^{f}, Xⱼ₋₁^{f}, Xⱼ₋₂^{f})
δ₁ and g₁ being proper positive constants, and
F₁ being a nonlinear function; and
updating a predictor coefficient a₂^{j} according to the equation:
a₂^{j+1}=a₂^{j}(1−δ₂)+g₂·F₂(Xⱼ^{f}, Xⱼ₋₁^{f}, Xⱼ₋₂^{f}, a₁^{j})
δ₂ and g₂ being proper positive constants, and
F₂ being a nonlinear function.

37. A digital circuit embodying instructions to perform a method for adapting coefficients in a two pole predictor in an adaptive differential pulse code modulation system, the method steps comprising:
generating a filtered reconstructed signal X^{f}ⱼ by a whitening filter, the filtered reconstructed signal X^{f}ⱼ being generated according to the equation:
X^{f}ⱼ=Xⱼ−a^{f}₁Xⱼ₋₁−a^{f}₂Xⱼ₋₂− . . . a^{f}ₙX^{f}ⱼ₋ₙ
X^{f}ⱼ₋ₙ being a value of filtered reconstructed signal X^{f}ⱼ at sample period i−n, and
n being a number of filter tap coefficients a^{f}ₙ corresponding to the whitening filter;
updating a predictor coefficient a₁^{j} according to the equation:
a₁^{j+1}=a₁^{j}(1−δ₁)+g₁·F₁(Xⱼ^{f}, Xⱼ₋₁^{f}, Xⱼ₋₂^{f})
δ₁ and g₁ being proper positive constants, and
F₁ being a nonlinear function; and
updating a predictor coefficient a₂^{j} according to the equation:
a₂^{j+1}=a₂^{j}(1−δ₂)+g₂·F₂(Xⱼ^{f}, Xⱼ₋₁^{f}, Xⱼ₋₂^{f}, a₁^{j})
δ₂ and g₂ being proper positive constants, and
F₂ being a nonlinear function.

38. An adaptive differential pulse code modulation system comprising:
at a first instance:
means for deriving a difference signal Eⱼ, the difference signal Eⱼ being the difference between an input signal Yⱼ and a predicted signal Sⱼ, j representing a sample period;
means for quantizing the difference signal Eⱼ to obtain a numerical representation Nⱼ;
means for deriving a regenerated difference signal Dⱼ based on the numerical representation Nⱼ;
means for transmitting the numerical representation Nⱼ to an inverse quantizing means coupled to the quantizing means through a network;
means for deriving a reconstructed input signal Xⱼ, the reconstructed input signal Xⱼ being the sum of the regenerated difference signal Dⱼ and the predicted signal Sⱼ;
means for generating a filtered reconstructed signal X^{f}ⱼ, the filtered reconstructed signal X^{f}ⱼ being generated according to the equation:
X^{f}ⱼ=Xⱼ−a^{f}₁Xⱼ₋₁−a^{f}₂Xⱼ₋₂− . . . a^{f}ₙX^{f}ⱼ₋ₙ
X^{f}ⱼ₋ₙ being a value of filtered reconstructed signal X^{f}ⱼ at sample period j−n, and
n being a number of coefficients a^{f}ₙ corresponding to the means for generating a filtered reconstructed signal;
means for generating a predicted signal Sⱼₚ, the predicted signal Sⱼₚ being at least constituent to predicted signal Sⱼ and being generated according to the equation:
Sⱼₚ=a^{j}₁Sⱼ₋₁−a^{j}₂Sⱼ₋₂− . . . a^{j}ₙₚSⱼ₋ₙₚ
Sⱼ₋ₙₚ being a value of the predicted signal Sⱼ at sample period j−nₚ, and
nₚ being a number of predictor coefficients a^{j}ₙₚ corresponding to the means for generating a predicted signal; and
feedback means for applying the predicted signal Sⱼ to the means for deriving a reconstructed input signal Xⱼ;
at a second instance:
the inverse quantizing means for deriving the regenerated difference signal Dⱼ from the numerical representation Nⱼ;
second means for deriving a reconstructed input signal Xⱼ, the reconstructed input signal Xⱼ being the sum of the regenerated difference signal Dⱼ and the predicted signal Sⱼ;
second means for generating a filtered reconstructed signal X^{f}ⱼ, the filtered reconstructed signal X^{f}ⱼ being generated according to the equation:
X^{f}ⱼ=Xⱼ−a^{f}₁Xⱼ₋₁−a^{f}₂Xⱼ₋₂− . . . a^{f}ₙX^{f}ⱼ₋ₙ
X^{f}ⱼ₋ₙ being a value of filtered reconstructed signal X^{f}ⱼ at sample period j−n, and
n being a number of coefficients a^{f}ₙ corresponding to the second means for generating a filtered reconstructed signal;
second means for generating a predicted signal Sⱼₚ, the predicted signal Sⱼₚ being at least constituent to predicted signal Sⱼ and being generated according to the equation:
Sⱼₚ=a^{j}₁Sⱼ₋₁−a^{j}₂Sⱼ₋₂− . . . a^{j}ₙₚSⱼ₋ₙₚ
Sⱼ₋ₙₚ being a value of the predicted signal Sⱼ at sample period j−nₚ, and
nₚ being a number of coefficients a^{j}ₙₚ corresponding to the means for generating a predicted signal; and
feedback means for applying the predicted signal Sⱼ to the means for deriving a reconstructed input signal Xⱼ.
